(19) United States
(12) Patent Application Publication
(10) Pub. No.: US 2020/0125967 A1
(43) Pub. Date: Apr. 23, 2020

(54) ELECTRONIC DEVICE AND METHOD FOR CONTROLLING THE ELECTRONIC DEVICE

(71) Applicant: SAMSUNG ELECTRONICS CO., LTD., Suwon-si (KR)

(72) Inventors: Sungmok SEO, Suwon-si (KR); Byungjoon CHANG, Seoul (KR); Sehoon KIM, Suwon-si (KR); Jeongsu SEOL, Suwon-si (KR); Jaehun LEE, Suwon-si (KR)

(73) Assignee: SAMSUNG ELECTRONICS CO., LTD., Suwon-si (KR)

(21) Appl. No.: 16/656,761

(22) Filed: Oct. 18, 2019

(30) Foreign Application Priority Data
Oct. 18, 2018 (KR) 10-2018-0124626

(51) Int. Cl. G06N 5/02; G06N 20/00

(52) U.S. Cl. CPC G06N 5/022; G06N 20/00

(57) ABSTRACT

An electronic device includes a memory including at least one instruction, and a processor configured to execute the at least one instruction to, based on receiving a user inquiry, identify whether a response to the received user inquiry is present in a personal knowledge base that is included in the memory, based on the response to the received user inquiry being identified to be present in the personal knowledge base, acquire the response to the received user inquiry, from the personal knowledge base, and based on the response to the received user inquiry being identified to not be present in the personal knowledge base, change a first text included in the received user inquiry to a second text, and acquire, from an external server, the response to the received user inquiry, using the second text to which the first text is changed.

### CROSS-REFERENCE TO RELATED APPLICATIONS

This application is based on and claims priority under 35 U.S.C. § 119(a) to Korean Patent Application No. 10-2018-0124626, filed on Oct. 18, 2018, in the Korean Intellectual Property Office, the disclosure of which is incorporated by reference herein in its entirety.

### BACKGROUND

### 1. Field

The disclosure relates to an electronic device and a controlling method thereof. More particularly, the disclosure relates to an electronic device for providing a response to a user inquiry using a personal knowledge database, and a controlling method thereof.

### 2. Description of Related Art

In recent years, artificial intelligence (AI) systems have been used in various fields. An AI system is a system in which a machine learns, judges, and becomes smart, unlike an existing rule-based smart system. As the use of AI systems improves, a recognition rate and understanding or anticipation of a user's taste may be performed more accurately. As such, existing rule-based smart systems are gradually being replaced by deep learning-based AI systems.

AI technology is composed of machine learning (for example, deep learning) and elementary technologies that utilize machine learning.

Machine learning is an algorithm technology that is capable of classifying or learning characteristics of input data. Element technology is a technology that simulates functions such as recognition and judgment of a human brain using machine learning algorithms such as deep learning. Machine learning is composed of technical fields such as linguistic understanding, visual understanding, reasoning, prediction, knowledge representation, motion control, or the like.

Various fields in which AI technology is applied are as shown below. Linguistic understanding is a technology for recognizing, applying, and/or processing human language or characters and includes natural language processing, machine translation, dialogue system, question and answer, voice recognition or synthesis, and the like. Visual understanding is a technique for recognizing and processing objects as human vision, including object recognition, object tracking, image search, human recognition, scene understanding, spatial understanding, image enhancement, and the like. Inference prediction is a technique for judging and logically inferring and predicting information, including knowledge-based and probability-based inference, optimization prediction, preference-based planning, recommendation, or the like. Knowledge representation is a technology for automating human experience information into knowledge data, including knowledge building (data generation or classification), knowledge management (data utilization), or the like. Motion control is a technique for controlling the autonomous running of the vehicle and the motion of the robot, including motion control (navigation, collision, driving), operation control (behavior control), or the like.

In recent years, various services using an AI agent (for example, Bixby™ Assistant™, Alexa™, etc.) for providing a response to a user inquiry have been provided. However, when using the AI agent, there is a limitation of providing an awkward answer that the AI agent does not understand for terminology personally used by a user or terminology that is not generally used. In other words, when making a dialog with the AI agent, in a related-art, a dialog may be performed using only some terminology that is common and clear. Thus, there is a limitation of having an awkward dialog with the AI agent.

### SUMMARY

Provided are an electronic device and a method for controlling the electronic device.

Additional aspects will be set forth in part in the description that follows and, in part, will be apparent from the description, or may be learned by practice of the presented embodiments.

According to embodiments, an electronic device includes a memory including at least one instruction, and a processor configured to execute the at least one instruction to, based on receiving a user inquiry, identify whether a response to the received user inquiry is present in a personal knowledge base that is included in the memory, based on the response to the received user inquiry being identified to be present in the personal knowledge base, acquire the response to the received user inquiry, from the personal knowledge base, and based on the response to the received user inquiry being identified to not be present in the personal knowledge base, change a first text included in the received user inquiry to a second text, and acquire, from an external server, the response to the received user inquiry, using the second text to which the first text is changed.

The personal knowledge base may be learned based on any one or any combination of user profile information, a user interaction that is input to the electronic device, a user search history, sensing information that is sensed by the electronic device, and user information that is received from an external device.

The personal knowledge base may store one or more objects, a relation among the one or more objects, an attribute of the one or more objects in a format of a table or a graph, and include data in which a relation or an attribute of the one or more objects is stored in a plurality of formats.

The processor may be further configured to execute the at least one instruction to generate the personal knowledge base by inputting, to a learned artificial intelligence (AI) model, any one or any combination of the user profile information, the user interaction input to the electronic device, the user search history, the sensing information sensed by the electronic device, and the user information received from the external device, to acquire a knowledge graph including relation information among knowledge information. The learned AI model may be an AI algorithm that is learned using any one or any combination of machine learning, neural network, genetic, deep learning, and classification algorithms.

The processor may be further configured to execute the at least one instruction to receive additional knowledge information from the external server, by requesting, from the external server, the additional knowledge information that is related to the personal knowledge base, and expand the personal knowledge base, based on the received additional knowledge information.

The first text may be not defined in a dictionary and may be personally used by a user using the electronic device, and the second text may correspond to the first text, and may be defined in the dictionary.

The second text may be determined based on user history information and user preference information that are stored in the personal knowledge base, among a plurality of texts corresponding to the first text.

The processor may be further configured to execute the at least one instruction to control to output a message for confirming the user inquiry in which the first text is changed to the second text.

The processor may be further configured to execute the at least one instruction to generate a search keyword, using the second text to which the first text is changed, control to transmit the generated search keyword to the external server, and receive, from the external server, a response to the transmitted search keyword.

The processor may be further configured to execute the at least one instruction to update the personal knowledge base, based on the received response to the transmitted search keyword.

According to embodiments, a controlling method for an electronic device, includes based on receiving a user inquiry, identifying whether a response to the received user inquiry is present in a personal knowledge base included in a memory of the electronic device, based on the response to the received user inquiry being identified to be present in the personal knowledge base, acquiring the response to the received user inquiry, from the personal knowledge base, and based on the response to the received user inquiry being identified to not be present in the personal knowledge base, changing a first text included in the received user inquiry to a second text, and acquiring, from an external server, the response to the received user inquiry, using the second text to which the first text is changed.

The personal knowledge base may be learned based on any one or any combination of user profile information, a user interaction that is input to the electronic device, a user search history, sensing information that is sensed by the electronic device, and user information that is received from an external device.

The personal knowledge base may store one or more objects, a relation among the one or more objects, an attribute of the one or more objects in a format of a table or a graph, and includes data in which a relation or an attribute of the one or more objects is stored in a plurality of formats.

The controlling method may further include generating the personal knowledge base by inputting, to a learned artificial intelligence (AI) model, any one or any combination of the user profile information, the user interaction input to the electronic device, the user search history, the sensing information sensed by the electronic device, and the user information received from the external device, to acquire a knowledge graph including relation information among knowledge information. The learned AI model may be an AI algorithm that is learned using any one or any combination of machine learning, neural network, genetic, deep learning, and classification algorithms.

The controlling method may further include receiving additional knowledge information from the external server, by requesting, from the external server, the additional knowledge information that is related to the personal knowledge base, and expanding the personal knowledge base, based on the received additional knowledge information.

The first text may be not defined in a dictionary and is personally used by a user using the electronic device, and the second text may be a generalized text corresponding to the first text.

The second text may be determined based on user history information and user preference information that are stored in the personal knowledge base, among a plurality of texts corresponding to the first text.

The controlling method may further include outputting a message for confirming the user inquiry in which the first text is changed to the second text.

The controlling method may further include generating a search keyword, using the second text to which the first text is changed, transmitting the generated search keyword to the external server, and receiving, from the external server, a response to the transmitted search keyword.

The controlling method may further include updating the personal knowledge base, based on the received response to the transmitted search keyword.

According to embodiments, a non-transitory computer-readable storage medium stores instructions configured to cause a processor of an electronic device to receive a user inquiry, identify whether a response to the received user inquiry is present in a personal knowledge base that is included in a memory of the electronic device, and based on the response to the received user inquiry being identified to be present in the personal knowledge base, acquire the response to the received user inquiry, from the personal knowledge base. The instructions further cause the processor to, based on the response to the received user inquiry being identified to not be present in the personal knowledge base, change a first text included in the received user inquiry to a second text, control to transmit, to an external server, a search keyword including the second text to which the first text is changed, receive, from the external server, the response to the received user inquiry, based on the transmitted search keyword, and control to output the response to the received user inquiry that is acquired or received.

The first text may be not defined in a dictionary and may be personally used by a user using the electronic device, and the second text may correspond to the first text, and may be defined in the dictionary.

The search keyword may further include user profile information and sensing information that is sensed by the electronic device.

The instructions may further cause the processor to transmit, to the external server, a portion of the personal knowledge base, receive, from the external server, additional knowledge information that is related to the transmitted portion of the personal knowledge base, and expand the personal knowledge base, based on the received additional knowledge information.

### BRIEF DESCRIPTION OF THE DRAWINGS

The above and other aspects, features, and advantages of embodiments of the disclosure will be more apparent from the following description taken in conjunction with the accompanying drawings, in which:

FIG. 1 is a usage diagram of an artificial intelligence (AI) agent system providing a response to a user inquiry, according to embodiments;

FIG. 2 is a block diagram illustrating a configuration of an electronic device, according to embodiments;

FIG. 3 is a block diagram illustrating a configuration of an electronic device, according to embodiments;

FIG. 4 is a block diagram illustrating a dialogue system of an AI agent system, according to embodiments;

FIG. 5 is a sequence diagram provided to describe an example of providing a response to a user inquiry by an AI agent system, according to embodiments;

FIGS. 6, 7, 8 and 9 are views describing examples of changing a text included in a user inquiry by an AI agent system and providing a response to the user inquiry using the changed text, according to embodiments;

FIG. 10 is a flowchart to describe a controlling method for an electronic device to provide a response to a user inquiry, according to embodiments;

FIG. 11 is a view provided to describe an operation of an electronic device using an AI model, according to embodiments;

FIG. 12 is a flowchart of a network system using an AI agent model, according to embodiments; and

FIGS. 13, 14, 15A and 15B are views provided to describe a method for generating or expanding a personal knowledge base, according to embodiments.

### DETAILED DESCRIPTION

The disclosure addresses at least the above-mentioned problems and/or disadvantages and to provide at least advantages described below. Accordingly, the disclosure provides an electronic device that is capable of providing natural dialogue with an artificial intelligence (AI) agent by changing a text included in a user inquiry, using a personal knowledge base, and providing a response using the changed text, and a controlling method thereof.

As described below, by changing a text included in a user inquiry to another text and providing a response to the user inquiry, a more natural dialogue with an AI agent is available. Therefore, a user may be provided with more diversified user environments.

Hereinafter, embodiments of the disclosure will be described with reference to the accompanying drawings. However, this disclosure is not intended to limit the embodiments described herein but includes various modifications, equivalents, and/or alternatives. In the context of the description of the drawings, like reference numerals may be used for similar components.

In this document, the expressions “have,” “may have,” “including,” or “may include” may be used to denote the presence of a feature (e.g., a numerical value, a function, an operation), and does not exclude the presence of additional features.

In this document, the expressions “A or B,” “at least one of A and/or B,” or “one or more of A and/or B,” and the like include all possible combinations of the listed items. For example, “A or B,” “at least one of A and B,” or “at least one of A or B” includes (1) at least one A, (2) at least one B, (3) at least one A and at least one B all together.

The terms such as “first,” “second,” and so on may be used to describe a variety of elements, but the elements may not be limited by these terms. The terms are labels used only for the purpose of distinguishing one element from another.

It is to be understood that an element (e.g., a first element) is “operatively or communicatively coupled with/to” another element (e.g., a second element) is that any such element may be directly connected to the other element or may be connected via another element (e.g., a third element). On the other hand, when an element (e.g., a first element) is “directly connected” or “directly accessed” to another element (e.g., a second element), it can be understood that there is no other element (e.g., a third element) between the other elements.

Herein, the expression “configured to” can be used interchangeably with, for example, “suitable for,” “having the capacity to,” “designed to,” “adapted to,” “made to,” or “capable of.” The expression “configured to” does not necessarily mean “specifically designed to” in a hardware sense. Instead, under some circumstances, “a device configured to” may indicate that such a device can perform an action along with another device or part. For example, the expression “a processor configured to perform A, B, and C” may indicate an exclusive processor (e.g., an embedded processor) to perform the corresponding action, or a generic-purpose processor (e.g., a central processor (CPU) or application processor (AP)) that can perform the corresponding actions by executing one or more software programs stored in the memory device.

An electronic device in accordance with embodiments of the disclosure may include any one or any combination of, for example, smartphones, tablet PCs, mobile phones, video telephones, electronic book readers, desktop PCs, laptop PCs, netbook computers, workstations, servers, a PDA, a portable multimedia player (PMP), an MP3 player, a medical device, a camera, or a wearable device. A wearable device may include any one or any combination of the accessory type (e.g., as a watch, a ring, a bracelet, a bracelet, a necklace, a pair of glasses, a contact lens or a head-mounted-device (HMD)); a fabric or a garment-embedded type (e.g., a skin pad or a tattoo); or a bio-implantable circuit. In some embodiments, the electronic apparatus may be, for example, a television, a digital video disk (DVD) player, audio, refrigerator, cleaner, ovens, microwaves, washing machines, air purifiers, set top boxes, home automation control panels, security control panels, media box (e.g., Samsung HomeSync™, Apple TV™, or Google TV™), game consoles (e.g., Xbox™ PlayStation™), electronic dictionary, electronic key, camcorder, or electronic frame.

In other embodiments, the electronic device may include any one or any combination of a variety of medical devices (e.g., various portable medical measurement devices such as a blood glucose meter, a heart rate meter, a blood pressure meter, or a temperature measuring device), magnetic resonance angiography (MRA), magnetic resonance imaging (MRI), computed tomography (CT), or ultrasonic wave device, etc.), navigation system, global navigation satellite system (GNSS), event data recorder (EDR), flight data recorder (FDR), automotive infotainment devices, marine electronic equipment (e.g., marine navigation devices, gyro compasses, etc.), avionics, security devices, car head units, industrial or domestic robots, drone, ATMs, points of sale of stores, or IoT devices (e.g., light bulbs, sensors, sprinkler devices, fire alarms, thermostats, street lights, toasters, exercise equipment, hot water tanks, heater, boiler, etc.).

In this disclosure, the term user may refer to a person who uses an electronic apparatus or an apparatus (example: artificial intelligence electronic apparatus) that uses an electronic apparatus.

Hereinafter, the embodiments will be described in a greater detail with reference to the drawings.

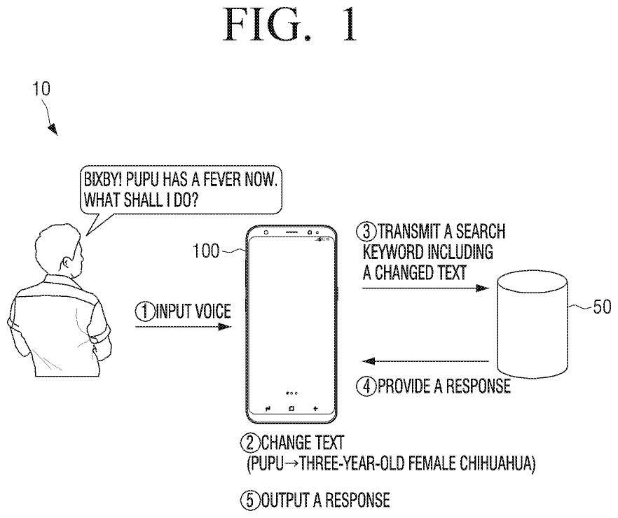

FIG. 1 is a usage diagram of an artificial intelligence (AI) agent system providing a response to a user inquiry, according to embodiments.

An AI system 10 may include an electronic device 100 and a response providing server 50 as shown in FIG. 1. The electronic device 100 may use the AI program to provide a user with a response to a user inquiry. The electronic device 100 may store a personal knowledge base in a memory. At this time, the personal knowledge base is a base for storing knowledge information of a personal user who uses the electronic device 100, and may be learned based on various information such as information of a profile of a user using the electronic device 100, user interaction input by the user to the electronic device 100, a user's search history, sensing information sensed by an electronic device (for example, location information acquired by a global positioning system (GPS), image information acquired by a camera, or the like), user information received from an external device, or the like. The electronic device 100 may generate the personal knowledge base by acquiring a knowledge graph including information on a relation among knowledge information, by inputting any one or any combination of the user profile information, user interaction input to the electronic device 100, user's search history, sensing information sensed by the electronic device 100, and user information received from the external device into a learned AI model. At this time, the learned AI model may be an AI algorithm that is learned using any one or any combination of machine learning, neural network, genetic, deep learning, and classification algorithms.

The personal knowledge base learned by various information of the user may be stored in a form of a knowledge graph of an ontology such as a resource description framework (RDF), web ontology language (OWL), or the like. In the case of storing knowledge information in the form of a knowledge graph, when new knowledge information is acquired, the electronic device 100 may request additional information about new knowledge information from an external server, update a relation between the additional information requested from the server and new knowledge information, and store the updated relation. In addition, the electronic device 100 may update the personal knowledge base based on the response to the user inquiry. The personal knowledge information may store a relation among knowledge information (or objects) in the form of a graph, but this is an example, and may store knowledge information learned by various information of a user in the form of a data set.

The electronic device 100 may receive an input of a user inquiry from a user. At this time, as illustrated in FIG. 1, the electronic device 100 may receive an input of a user inquiry through a user voice, but this is an example, and may receive a user inquiry through various input methods such as a touch input, a keyboard input, or the like.

The electronic device 100 may receive a user voice including a trigger word for activating the AI agent program before receiving a user inquiry. For example, the electronic device 100 may receive a user voice including a trigger word such as “Bixby” before receiving a user inquiry. When the user voice including the trigger word is input, the electronic device 100 may execute or activate the AI agent program and wait for input of the user inquiry. The AI agent program may include a dialogue system that may process a user inquiry and response in a natural language. At this time, in addition to the trigger word for activating the AI agent program, a button provided in the electronic device 100 may be selected, and a user voice may be input.

The electronic device 100 may receive a user voice including a user inquiry. For example, the electronic device 100 may receive a user inquiry of “PuPu has a fever now. What shall I do?” from a user. At this time, the user inquiry may include a first text like “PuPu” that a user personally uses and is not defined in a dictionary. In the meantime, that the first text, among a plurality of texts, included in the user inquiry is a text that is not defined in a dictionary and is personally used by a user is an example, and even if a text is defined in a dictionary, if the text is used by a user as another meaning, the text may be the first text.

At this time, electronic devices 100 may provide a response to a user inquiry using the personal knowledge base. If there is a user inquiry having a similar intention of the user inquiry, and there is a response to the user inquiry in the personal knowledge base, the electronic device 100 may provide a response to a user inquiry using the personal knowledge base.

However, when there is no response to the user inquiry in the personal knowledge base, the electronic device 100 may convert the first text included in the user inquiry into a second text using the personal knowledge base stored in the electronic device 100 before requesting a response to a response providing server 50. At this time, the second text may be a text for describing the first text or corresponding to the first text, and a general text that is defined in a dictionary. For example, if a user inquiry “PuPu has a fever now. What shall I do?” is input, the electronic device 100 may determine the text “PuPu” that is personally used by the user, among the texts included in the user inquiry. The electronic device 100 may convert the text “PuPu” into a text “three-year-old female Chihuahua” based on the knowledge information stored in personal knowledge base.

The electronic device 100, prior to providing a search keyword for receiving a response to the response providing server 50, may output a confirmation message to confirm a converted text. For example, the electronic device 100 may output a confirmation message, “Does a three-year-old female Chihuahua have a fever? May I tell you a solution?” At this time, the confirmation message may be provided as a voice message, but this is an example, and may be implemented as a visual message displayed on a display.

Through the confirmation message, when a positive feedback requesting a response providing is input (for example, a user response “Yes, let me know” is input), the electronic device 100 may transmit a user inquiry including the converted text to the response providing server 50. For example, the electronic device 100 may provide the response providing server 50 with a keyword “three-year-old female Chihuahua, fever, solution,” instead of transmitting the search keyword to the response providing server 50.

At this time, the electronic device 100 may provide not only search keywords but also various context information to the response providing server 50. For example, the electronic device 100 may provide the response providing server 50 with either one or both of user profile information (for example, user preference information, search information, or the like) and the sensing information (for example, location information, or the like) sensed by the electronic device 100 as well.

The response providing server 50 may provide a response to a user inquiry based on either one or both of the search keyword and context information received from the electronic device 100. For example, the response providing server 50 may provide a response “taking 3 cc of fever reducer for a dog, taking a fever reducer for a human not permitted” for the user inquiry, and, based on the user location information, may provide a response “Woomyeon-dong, O O Animal Hospital, medical treatment available, call connection.” The response providing server 50 may provide a response including a text, as described above, but this is an example, and may provide a natural language-type response.

The response providing server 50 may transmit a response to the user inquiry to the electronic device 100.

The electronic device 100 may output a response. At this time, the electronic device 100 may process and output a response in a natural language using the dialogue system. For example, natural language response, “if there is a dog fever reducer, give the dog 3 cc, but never use a human fever reducer, why don't you go see Woomyeon-dong O O hospital? May I put you through right away?” may be provided. In addition, the electronic device 100 may output a response via a display, but this is an example, and may output the response through a speaker.

In addition, the electronic device 100 may receive a response from the response providing server 50 and output the response, but this is an example, and the electronic device 100 may perform web search using the converted text. For example, the electronic device 100 may perform a web search through the search keyword “three-year-old female Chihuahua fever solution.” Further, the electronic device 100 may perform a web search through a search keyword “three-year-old female Chihuahua Woomyeon-dong Animal Hospital.”

The electronic device 100 may output a message requesting a confirmation for a response received from the response providing server 50. In addition, the electronic device 100, when receiving a plurality of responses from the response providing server 50, may receive an input of a user instruction for selecting one of a plurality of responses.

The electronic device 100 may update the personal knowledge base using the response received from the response providing server 50 and the user inquiry. That is, the electronic device 100 may store the relation of the user inquiry and the response in a form of a knowledge graph in the personal knowledge base, to provide a more rapid response, when a user inquiry of the similar intention is to be input later. If a user input confirming a response is received after a message requesting confirmation of the response is output, the electronic device 100 may update the personal knowledge base using the user inquiry and the response. In addition, when a user input for selecting one of the plurality of responses is received, the electronic device 100 may update the personal knowledge base using the user inquiry and the response selected by the user.

In the embodiments described above, the electronic device 100 receives a response to a user inquiry from an external server, but this is an example, and the electronic device 100 may provide a response to the user inquiry using the knowledge base stored in the electronic device 100.

In the embodiments described above, it has been described that the personal knowledge base is stored in the electronic device 100, but this is an example, and the personal knowledge base may be stored in a separate external server. At this time, the personal knowledge base stored in the external server may be accessed by the electronic device 100, only when log-in is performed by a separate user account.

In addition, in the above embodiments, it has been described that the first text used by the user is changed to the second text that is defined in a dictionary, but this is an example, and the first text may be changed to the second text based on various information stored in the personal knowledge base. A variety of embodiments will be described later.

In the above-described embodiments, it has been described that, in the case in which the user inquiry is input explicitly, the response to the user inquiry is provided. However, this is an example, and the electronic device 100 may extract the user inquiry by analyzing a text (for example, a social network service (SNS), message, e-mail, or the like). For example, when the user uploads tag information together with the dog on the SNS along with the tag information “# sick PuPu,” the electronic device 100 may automatically extract the user inquiry by analyzing the text input by the user. The electronic device 100 may then provide a response via the personal knowledge base based on the extracted user inquiry, or may provide a response by changing the first text (e.g., PuPu) to the second text (e.g., a dog).

The electronic device 100 may use the AI agent to provide a response to the above-mentioned user inquiry. At this time, the AI agent is a dedicated program to provide AI-based services (for example, voice recognition services, secretarial services, translation services, search services, etc.) and may be executed by existing general-purpose processors (for example, CPUs) or separate AI-only processors (for example, GPUs). The AI agent may control a variety of modules (for example, dialogue systems) to be described later.

A predetermined user voice (for example, a “Bixby” or the like) is input or a button (for example, a button for executing the AI agent) provided in the electronic device 100 is pressed, the AI agent may be operating. In addition, the AI agent may change the first text included in the user inquiry into the second text based on the personal knowledge base, and provide a response to the user inquiry based on the second text.

The AI agent may operate if a predetermined user voice (for example, “Bixby” or the like) is input or a button (for example, a button for executing the AI agent) provided in the electronic device 100 is pressed. In addition, the AI agent may be in a pre-executed state before the predetermined user voice (for example, “Bixby” or the like) is input or a button (for example, a button for executing the AI agent) provided in the electronic device 100 is pressed. In this case, after the predetermined user voice (for example, “Bixby” or the like) is input, or a button (for example, a button for executing the AI agent) provided in the electronic device 100 is pressed, the AI agent of the electronic device 100 may provide a response to the user inquiry. For example, when the AI agent is executed by an AI-dedicated processor, before a predetermined user voice (for example, “Bixby” or the like) is input or a button (for example, a button for executing the AI agent) provided in the electronic device 100 is pressed, a function of the electronic device 100 is executed by the general-purpose processor, and after the predetermined user voice (for example, “Bixby,” or the like) is input or the button (a button for executing the AI agent) provided in the electronic device 100 is pressed, a function of the electronic device 100 may be executed by the AI-dedicated processor.

In addition, agent may be in the standby state before a predetermined user voice (for example, “Bixby” or the like) is input or a button (a button for executing the AI agent) provided in the electronic device 100 is pressed. Here, the standby state that detects receiving a user input to control the start of an action of the AI agent. When a set user voice (for example, “Bixby” or the like) is input or a button (for example, a button for executing the AI agent) provided in the electronic device 100 is pressed, while the AI agent is in the standby state, the electronic device 100 may operate the AI agent and provide a response to the user inquiry using the operated AI agent.

The AI agent may be in a terminated state before a predetermined user voice (for example, “Bixby,” or the like) is input or a button (for example, a button for executing the AI agent) is pressed. While the AI agent is being terminated, when a predetermined user voice (for example, “Bixby” or the like) is input or a button (for example, a button for executing the AI agent) provided in the electronic device 100 is pressed, the electronic device 100 may execute the AI agent and provide a response to the user inquiry using the executed AI agent.

In the meantime, the AI agent may control various devices or modules to be described later. This will be described later.

Examples of changing a text included in the user inquiry using various models between the electronic device 100 and the server and providing a response using the changed text will be described through embodiments.

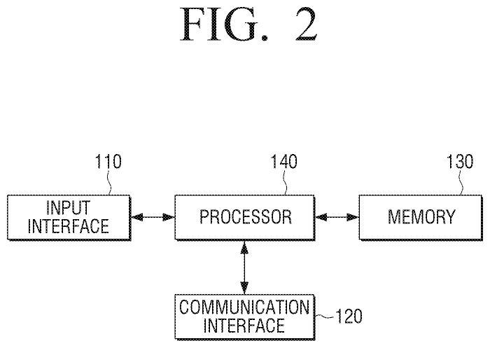

FIG. 2 is a block diagram illustrating a configuration of an electronic device, according to embodiments.

As illustrated in FIG. 2, the electronic device 100 may include an input interface 110, a communication interface 120, a memory 130, and a processor 140. The embodiments are not limited thereto and some configurations may be added or omitted according to a type of an electronic device.

The input interface 110 may receive a user input for controlling the electronic device 100. For example, the input interface 110 may receive various user manipulations such as a user touch of a user and a user voice for controlling the electronic device 100. The input interface 110 may receive a user inquiry for acquiring knowledge information.

The communication interface 120 may communicate with an external electronic device. The communication interface 120 is a configuration to communicate with an external device. Communication with the communication interface 120 with an external device may include communication via a third device (for example, a repeater, a hub, an access point, a server, a gateway, or the like). Wireless communication may include cellular communication using any one or any combination of the following, for example, long-term evolution (LTE), LTE advanced (LTE-A), a code division multiple access (CDMA), a wideband CDMA (WCDMA), and a universal mobile telecommunications system (UMTS), a wireless broadband (WiBro), or a global system for mobile communications (GSM) and the like. According to embodiments, the wireless communication may include, for example, any one or any combination of wireless fidelity (Wi-Fi), Bluetooth, Bluetooth low energy (BLE), Zigbee, near field communication (NFC), magnetic secure transmission, radio frequency (RF), or body area network (BAN). Wired communications may include any one or any combination of, for example, a universal serial bus (USB), a high definition multimedia interface (HDMI), a recommended standard 232 (RS-232), a power line communication, or a plain old telephone service (POTS). The network over which the wireless or wired communication is performed may include any one or any combination of a telecommunications network, for example, a computer network (for example, local area network (LAN) or wide area network (WAN)), the Internet, or a telephone network.

The communication interface 120 may perform communication with an external server and provide the AI agent service. The communication interface 120 may transmit a user inquiry including the changed text to the external server, and acquire a response to the user inquiry.

The memory 130 may store instructions or data related to at least one other component of the electronic device 100. The memory 130 may be implemented as a non-volatile memory, a volatile memory, a flash memory, a hard disk drive (HDD), a solid state drive (SSD), or the like. The memory 130 is accessed by the processor 140 and reading/writing/modifying/deleting/updating of data by the processor 140 may be performed. In the disclosure, the term memory may include the memory 130, read-only memory (ROM) in the processor 140, RAM, or a memory card (for example, a micro SD card, and a memory stick) mounted to the electronic device 100. In addition, the memory 130 may store programs and data for configuring various screens to be displayed in the display area of the display.

The memory 130 may store the AI gent for operating the dialogue system. The electronic device 100 may use the AI agent to generate a natural language as a response to the user utterance. At this time, the AI agent is a dedicated program for providing an AI-based service (for example, a voice recognition service, secretarial service, translation service, search service, or the like). The AI agent may be executed by the existing general use processor (for example, central processing unit (CPU)) or a separate AI-specific processor (for example, graphics processing unit (GPU), or the like).

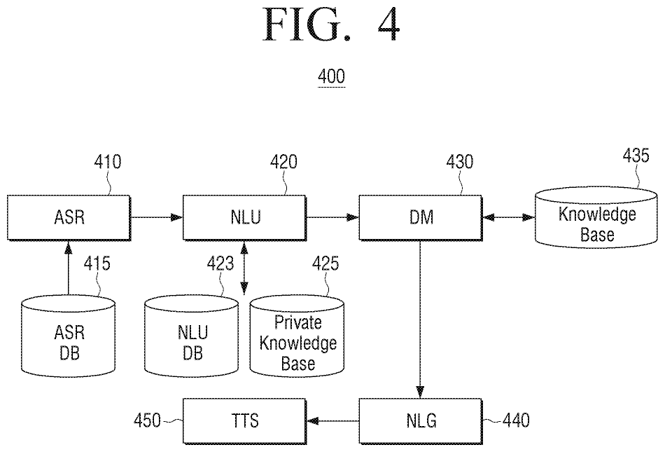

In addition, the memory 130 may include a plurality of configurations (or modules) constituting the dialogue system as illustrated in FIG. 4. The memory 130 may include the personal knowledge base learned by a user using the electronic device 100. This will be further described with reference to FIG. 4.

The processor 140 may be electrically connected to the memory 130 to control the overall action and function of the electronic device 100. The processor 140 may execute at least one instruction stored in the memory 130 and, when a user inquiry is input, the processor 140 may change the first text included in the user inquiry to the second text, based on the personal knowledge base stored in the memory 130. The processor 140 may then output the acquired response.

The processor 140 may receive a user inquiry through the input interface 110. At this time, the user inquiry may include the first text that is not defined in a dictionary but is frequently used by a personal user.

The processor 140 may change the first text included in the user inquiry to the second text using the personal knowledge base stored in the memory 130. For example, the first text is the text that is not defined in a dictionary and is used personally by the user who uses an electronic device, the second text corresponds to the first text, and may be a text that is defined in a dictionary. However, that the first text is not defined in a dictionary is only an example, and if the first text is defined in a dictionary, the first text may be changed to the second text based on the knowledge information stored in the personal knowledge base. For example, the second text may be a text that is determined based on user history information and user preference information stored in the personal knowledge base among a plurality of texts corresponding to the first text.

The processor 140 may output a message inquiring the user inquiry that is changed based on the changed second text. For example, the processor 140 may output a message for confirming a changed user inquiry based on the changed text through a display or a speaker.

When the input for user inquiry is received, the processor 140 may generate a search keyword using the changed second text, and control the communication interface 120 to transmit the generated search keyword to an external server (for example, a response providing server 50). The processor 140 may control the communication interface 120 to transmit the sensing information (for example, location information) sensed by the electronic device and user information (for example, user preference information, user search information, or the like) to the external server 50, along with the search keywords.

The processor 140 may receive a response to the search keyword from the external server 50 through the communication interface 120, and output a received response. At this time, the processor 140 may process the received response as a natural language through the dialogue system as illustrated in FIG. 4, and provide a response.

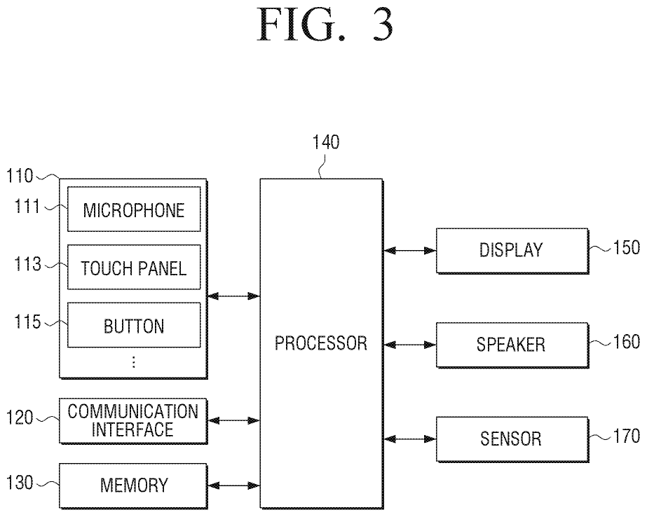

FIG. 3 is a block diagram illustrating a configuration of an electronic device, according to embodiments. As illustrated in FIG. 3, the electronic device 100 may include the input interface 110, the communication interface 120, a display 150, a speaker 160, a sensor 170, and the processor 140. The input interface 110, the communication interface 120, the memory 130, and the processor 140 in FIG. 3 have been described in FIG. 2 and will not be described.

The input interface 110 may receive user input to control the electronic device 100. The input interface 110 may receive user inquiry to acquire knowledge information. As illustrated in FIG. 3, the input interface 110 may include a microphone 111 for receiving an input of a user voice, a touch panel 113 for receiving a user touch using user hand or a stylus pen, and a button 115 for receiving a user manipulation, or the like. However, an example of the input interface 110 as illustrated in FIG. 3 is an example, and the input interface 110 may be implemented as other input devices (e.g., keyboard, mouse, motion inputter, or the like).

The display 150 may display various information according to a control of the processor 140. The display 150 may display a message to confirm a user inquiry including the changed text. In addition, the display 150 may display a response to the user inquiry. The display 150 may be implemented as a touch screen along with the touch panel 113.

The speaker 160 is a configuration to output not only various audio data processed as decoding, amplification, and noise filtering but also various notification sounds or voice message. The speaker 160 may output a response to the user inquiry as a voice message in a natural language format. The configuration to output audio may be implemented as a speaker, but this is an example and may be implemented as an output terminal for outputting audio data.

The sensor 170 may sense various status information of the electronic device 100. For example, the sensor 170 may include a motion sensor (e.g., a gyro sensor, an acceleration sensor, or the like) capable of sensing motion information of the electronic device 100, and may include a sensor for sensing position information (for example, a global positioning system (GPS) sensor), a sensor (for example, a temperature sensor, a humidity sensor, an air pressure sensor, and the like) capable of sensing environmental information around the electronic device 100, a sensor that can sense user information of the electronic device 100 (e.g., blood pressure sensors, blood glucose sensors, pulse rate sensors, etc.), and the like. In addition, the sensor 170 may further include an image sensor or the like for photographing the outside of the electronic device 100.

FIG. 4 is a block diagram illustrating a dialogue system of an AI agent system, according to embodiments.

A dialogue system 400 illustrated in FIG. 4 is a configuration for performing a dialogue via a natural language with a virtual AI agent, and according to embodiments, the dialogue system 400 may be stored inside the memory 130 of the electronic device 100. However, this is an example, and at least one included in the dialogue system 400 may be included in at least one external server.

As illustrated in FIG. 4, the dialogue system 400 may further include an automatic speech recognition (ASR) module 410, a natural language understanding (NLU) module 420, a dialogue manager (DM) module 430, a natural language generator (NLG) module 440, and a text to speech (TTS) module 450. The dialogue system 400 may further include a path planner module or an action planner module.

The ASR module 410 may convert user input (a user inquiry) received from the electronic device 100 into text data. For example, the ASR module 410 may include a speech recognition module. The speech recognition module may include an acoustic model and a language model. For example, the acoustic model may include information related to speech, and the language model may include information on unit phoneme information and a combination of unit phoneme information. The speech recognition module may convert the user utterance into text data using the information related to speech and information on the unit phoneme information. Information about the acoustic model and language model may be stored in, for example, an automatic speech recognition database (ASR DB) 415.

The natural language understanding module 420 may recognize the intention of a user by performing syntactic analysis or semantic analysis. Grammatical analysis may divide the user input in grammatical units (for example: words, phrases, morphemes, or the like), and grasp which grammatical elements the divided units have. The semantic analysis may be performed using semantic matching, rule matching, formula matching, or the like. Accordingly, the natural language understanding module 420 may acquire domain, intent, or parameter (or slot) to express the intent.

The natural language understanding module 420 may determine user intention and parameters using the matching rule divided into a domain, an intention, and a parameter (or a slot) for grasping the intention. For example, the natural language understanding module 420 may include the one domain (for example: an alarm) may include a plurality of intents (for example: alarm setting, alarm cancellation, or the like), and one intention may include a plurality of parameters (for example: time, repetition times, alarm sound, or the like). The plurality of rules may include, for example, one or more mandatory element parameters. The matching rule may be stored in a natural language understanding database (NLU DB) 423.

The natural language understanding module 420 may grasp the meaning of a word extracted from a user input using a linguistic characteristic (for example: a grammatical element) such as a morpheme or a phrase, and determine a user intention by matching the grasped meaning with the domain and the intention. For example, the natural language understanding module 420 may determine the user's intention by calculating how many words extracted from user input are included in each domain and intention. According to embodiments, the natural language understanding module 420 may determine the parameters of the user input using words that become a basis for understanding the intent. According to embodiments, the natural language understanding module 420 may determine the user's intention using the natural language recognition database 423 in which the linguistic characteristic for grasping the intention of the user input is stored.

The natural language understanding module 420 may understand a user inquiry by using a personal knowledge base 425. The natural language understanding module 420 may change the first text included in the user inquiry to the second text based on knowledge information included in the personal knowledge base 425. Here, the personal knowledge base 425 may learn relation among knowledge information using any one or any combination of user profile information (including not only personal information such as a user name, age, gender, body size but also user preference information, or the like, directly input by the user), user interaction input to the electronic device 100, user's search history, sensing information sensed by the electronic device 100, and user information received from an external device. At this time, a method through which knowledge information is learned may include attribute extraction, entity extraction, relational extraction, and co-reference resolution, which are methods of extracting knowledge from text, and linking work through entity disambiguation to knowledge base (Linking the extracted knowledge). At this time, the pre-learned language model may be used, or probability modeling and embedding technique may be used. In addition, knowledge base completion through link prediction, or the like, may also be performed.

At this time, the personal knowledge base 425 may store an object, a relation between objects, and an attribute of an object in a form of a table or a graph, and include data in which the relation or attribute of an object is stored in a plurality of forms. When the personal knowledge base 425 is first established, the electronic device 100 may construct the personal knowledge base 425 by requesting the external server for knowledge associated with information related to the user as well as various acquired information related to the user. At this time, an object may be named as a class, an entity, a parameter, or the like, and an attribute of an object may include an attribute type/attribute name or an attribute value.

In addition, when new knowledge information is added, the personal knowledge base 425 may receive additional information of new knowledge information from an external server and store knowledge information and additional information in the form of a knowledge graph. For example, if the information “PuPu-dog” is added to the personal knowledge base 425, various information about a dog may be received from an external server and stored in the form of a knowledge graph.

The personal knowledge base 425 storing knowledge information in a knowledge graph format is an example, and the personal knowledge base 425 may store information in a dataset format. For example, the personal knowledge base 425 may store data in a format of (PuPu, dog), (preferred music type, dance), or the like.

The natural language understanding module 420 may determine the user intent using the personal knowledge base 425. For example, the natural language understanding module 420 may determine the user intent using user information (for example: a preferred phrase, preferred content, contact list, music list, and the like). According to embodiments, not only the natural language understanding module 420 but also the ASR module 410 may recognize the user voice by referring to the personal knowledge base 425.

The natural language understanding module 420 may generate a path rule based on the intent and a parameter of a user input. For example, the natural language understanding module 420 may select an application to be executed based on the intention of a user input, and determine an action to be performed in the selected application. The natural language understanding module 420 may generate the path rule by determining a parameter corresponding to the determined action. According to embodiments, the path rule generated by the natural language understanding module 420 may include an application to be executed, an action to be executed in the application, and information about parameters to execute the action.

The natural language understanding module 420 may generate one path rule or a plurality of path rules based on the intention and parameter of the user input. For example, the natural language understanding module 420 may receive a path rule set corresponding to the electronic device 100 from a pass planner module, and determine the path rule by mapping the intention and the parameter of the user input to the received path rule set. At this time, the path rule may include information about an action (or operation) to perform a function of the application, or parameters to perform the action. In addition, the path rule may include an action sequence of an application. The electronic device may receive a password, select an application according to the password, and execute an action included in the password in the selected application.

The natural language understanding module 420 may generate one or a plurality of path rules by determining an application to be executed based on the intention and parameter of the user input, an action to be executed in an application, and a parameter to execute the action. For example, the natural language understanding module 420 may generate the path rule by arranging the application to be executed or the action to be executed by the application in an ontology or graph model according to the intention of the user input using the information of the electronic device 100. The generated path rule may be stored in, for example, path rule database. The generated path rule may be added to the path rule set of the database 423.

The natural language understanding module 420 may select at least one path rule from among a plurality of generated path rules. For example, the natural language understanding module 420 may select a plurality of optimal path rules. For example, the natural language understanding module 420 may select a plurality of path rules when only some actions are specified based on user utterance. The natural language understanding module 420 may determine one path rule among a plurality of path rules by the addition input of the user.

A dialogue manager module 430 may determine whether the intention of a user grasped by the natural language understanding module 420 is clear. For example, the dialogue manager module 430 may determine whether the intention of the user is clear based on whether the parameter information is sufficient. The dialogue manager module 430 may determine whether the parameter grasped in the natural language understanding module 420 is sufficient to perform a task. According to embodiments, the dialogue manager module 430 may perform feedback to request information to the user if the user intension is not clear. For example, the dialogue manager module 430 may perform the feedback to request information about parameters for grasping the user intention. In addition, the dialogue manager module 430 may generate and output a message for checking a user inquiry including the text changed by the natural language understanding module 420.

According to embodiments, the dialogue manager module 430 may include a content provider module. The content provider module, when it is possible to perform an action based on the intention grasped by the natural language understanding module 1220 and parameters, may generate a result of performing a task corresponding to the user input.

According to embodiments, the dialogue manager module 430 may provide a response to the user inquiry using a knowledge base 435 or the personal knowledge base 425. At this time, the knowledge base 435 may be included in the electronic device 100, but this is an example and may be included in an external server.

The natural language generation module (NLG module) 440 may change the designated information into a text form. The information changed in the text form may be a form of natural language utterance. The designated information may be, for example, information about an additional input, information for guiding completion of an action corresponding to a user input, or information for guiding an additional input of a user (for example: feedback information for a user input). The information changed in the text form may be displayed on the display 150 of the electronic device 100 or changed into a voice form by a text-to-speech (TTS) module 450.

The TTS module 450 may change the information of the text format to voice format information. The TTS module 450 may receive information of a text format from the natural language generation module 440, change the information of the text format into information of a voice format, and output the same through a speaker.

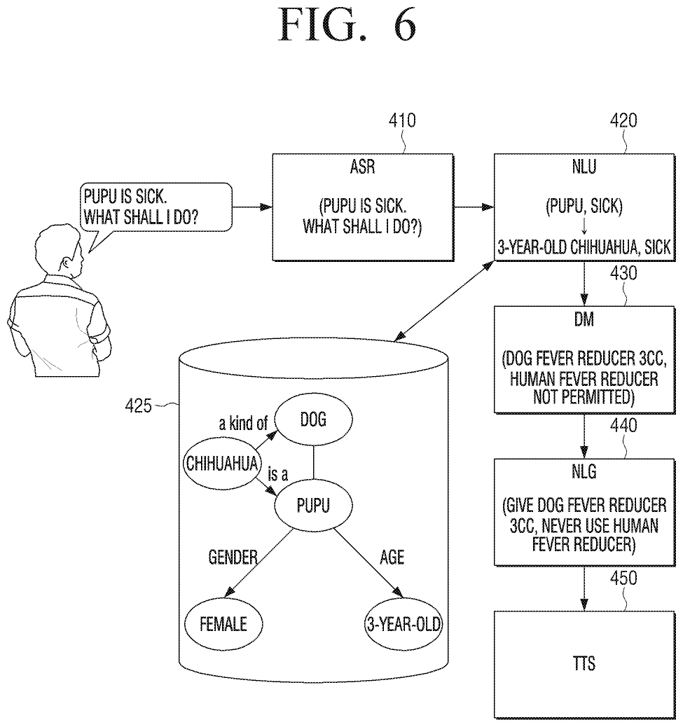

The natural language understanding module 420 and the dialogue manager module 430 may be implemented as one module. For example, the natural language understanding module 420 and the dialogue manager module 430 may be implemented as one module to determine the intention of the user and the parameter, and acquire a response (for example, path rule) corresponding to the determined user intention and the parameter of the user. As another example, the natural language understanding module 420 and the dialogue manager module 430 may convert the first text included in the user inquiry to the second text based on the personal knowledge base 425, and acquire a response to the user inquiry generated based on the converted second text. In the meantime, embodiments in which the natural language understanding module 420 (or the dialogue manager module 430) may convert the first text included in the user inquiry to the second text, and a response to the user inquiry generated based on the converted second text will be described in detail with reference to FIGS. 6-9.

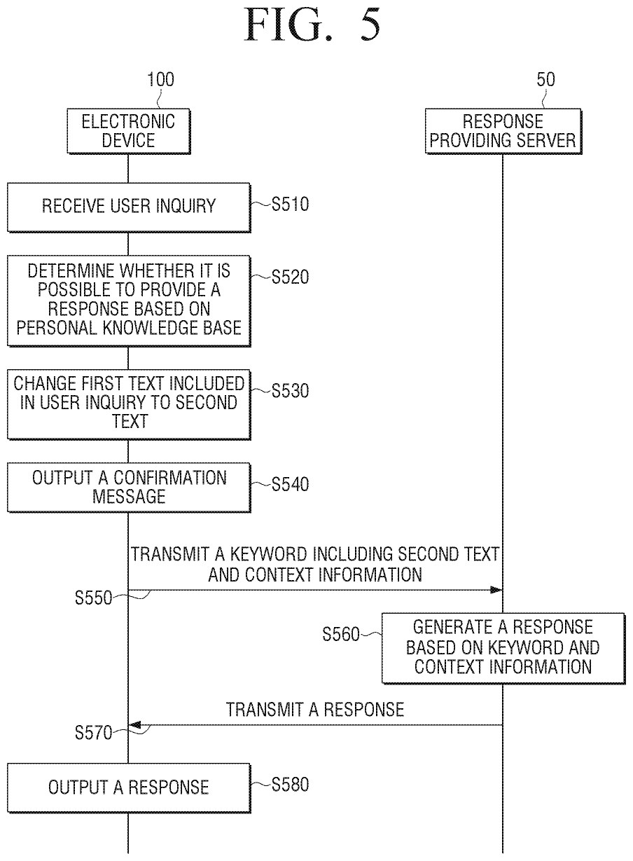

FIG. 5 is a sequence diagram provided to describe an example of providing a response to a user inquiry by an AI agent system, according to embodiments.

The electronic device 100 may receive a user inquiry in step S510. At this time, the input user inquiry may include a plurality of texts, and a plurality of texts may include a text that is not defined in a dictionary and is personally used by a user, or a text that is defined in a dictionary but is used by a user as a different meaning.

The electronic device 100 may determine whether it is possible to provide a response based on a personal knowledge base in step S520. That is, if there is a response to the user inquiry in the personal knowledge base, the electronic device 100 may provide a response to the user inquiry using the personal knowledge base. The electronic device 100 may acquire a response by searching knowledge information stored in the knowledge base through a rule-based technology or a learning model-based technology based on a text included in the user inquiry. However, if there is no response to the user inquiry in the personal knowledge base, the electronic device 100 may determine whether the text to be converted exists among the texts included in the user inquiry, and receive a response to the user inquiry from the external response providing server 50.

The electronic device 100 may convert a first text included in the user inquiry into a second text in step S530. If there is no response to the user inquiry in the personal knowledge base, the electronic device 100 may convert the first text included in the user inquiry into the second text. The electronic device 100 may determine the first text that is not defined in a dictionary and personally used by a user or the first text that is defined in a dictionary but is used as another meaning by a user, from among a plurality of texts included in the user inquiry based on the personal knowledge base 425, and change the determined first text to the second text corresponding to the first text. At this time, the second text is a text that has a relation value having a predetermined value or more with the first text in the personal knowledge base 425 in a form of the knowledge graph, and may have a meaning corresponding to the first text or defined in a dictionary text describing the first text.

The electronic device 100 may output a confirmation message to confirm the changed second text in step S540. The electronic device 100 may output a confirmation message including the user inquiry including the changed second text.

When a predetermined user input (for example, a positive feedback) is received through a confirmation message, the electronic device 100 may transmit a keyword including the second text and context information to the response providing server 50 in step S550. The electronic device 100 may acquire a keyword to obtain a response based on the user inquiry including the changed second text in response to a predetermined user input through the confirmation message. The electronic device 100 may acquire the context information to acquire a response. At this time, the context information may include the user profile information (for example, user's personal information, user preference information, user search information, or the like) and the sensing information (for example, location information, time information, temperature/humidity information, or the like) acquired by the sensor 170 of the electronic device 100. The electronic device 100 may transmit, to the response providing server 50, the acquired keyword and the context information together.

The response providing server 50 may generate a response based on the keyword and the context information in step S560. The response providing server 50 may acquire a response based on the changed second text and context information included in the keyword. Alternatively, the response providing server 50 may acquire a path rule, a control instruction, or the like, together with a response based on the second text and context information.

The response providing server 50 may transmit the generated response to the electronic device 100 in step S570. Here, the response may include a plurality of texts, images, uniform resource locator (URL), path rules, control instructions, or the like, but this is an example and other information may be included.

The electronic device 100 may output a received response in step S580. Here, the electronic device 100 may process and output the received response as a natural language through the natural language generation module 440.

FIGS. 6, 7, 8 and 9 are views describing examples of changing a text included in a user inquiry by an AI agent system and providing a response to the user inquiry using the changed text, according to embodiments.

Hereinafter, referring to FIGS. 6 to 9, embodiments in which the AI agent system changes a text included in a user inquiry and provides a response to the user inquiry using the searched text will be described.

FIG. 6 is a view to describe an example in which a text that is not defined in a dictionary and is personally used by a user is changed to a generalized text that is defined in a dictionary.

The electronic device 100 may receive an input of a user voice “PuPu is sick. What shall I do?” through a microphone. The electronic device 100 may receive a user voice including a predetermined trigger word (for example, Bixby) and active an AI agent, and then receive a user voice including the user inquiry.

The ASR module 410 may recognize a user voice in an audio format as a text format as “PuPu is sick. What shall I do.”

The natural language understanding module 420 may acquire intent of “inquiry” and parameters (or slots) of “PuPu, sick” using “PuPu is sick. What shall I do” in a text format.

The dialogue manager module 430 may determine whether there is a response corresponding to the intention and parameters acquired through the natural language understanding module 420 by using knowledge information stored in the personal knowledge base. At this time, if there is a response corresponding to the intention and parameters acquired through the natural language understanding module 420 in the personal knowledge base, the dialogue manager module 430 may provide a response to the user inquiry based on knowledge information stored in the personal knowledge base.

However, if a response corresponding to the intention and parameters acquired through the natural language understanding module 420 is not present in the personal knowledge base, the dialogue manager module 430 may request the natural language understanding module 420 to change a part of the texts included in the user inquiry.

The natural language understanding module 420 may determine a text that is not defined in a dictionary and is personally used by a user and a text that is defined in a dictionary but is used by the user as another meaning, among the parameters acquired based on the personal knowledge base 425. For example, the natural language understanding module 420 may determine a text “PuPu” that a user personally uses based on the knowledge information stored in the personal knowledge base 425 as illustrated in FIG. 6.

The natural language understanding module 420 may change the text determined based on the knowledge information stored in the personal knowledge base 425 to a general text that is defined in a dictionary. For example, the natural language understanding module 420 may change “PuPu” to “three-year-old female Chihuahua” based on the knowledge information stored in the personal knowledge base 425 illustrated in FIG. 6.

The dialogue manager module 430 may generate a search keyword using the changed parameter and transmit the search keyword to the external response providing server 50. That is, the dialogue manager module 430 may provide a keyword of “three-year-old female Chihuahua is sick” to the response providing server 50.

At this time, the dialogue manager module 430 may provide a confirmation message, “three-year-old female Chihuahua is sick. Shall I search a solution?” to confirm the changed text. Then, when a positive feedback (for example, a user voice of “Yes”) is received through the confirmation message, the dialogue manager module 430 may transmit a search keyword including the changed parameter to the external response providing server 50.

The dialogue manager module 430 may receive a response of “dog fever reducer 3 CC, taking a human fever reducer is not permitted” from the response providing server 50.

The natural language generation module 440 may generate a natural language response of “give a dog fever reducer 3 CC, never use a human fever reducer” based on the acquired response.

The TTS module 450 may process and output the acquired natural language response as a voice through the speaker 160. At this time, the electronic device 100 may provide the natural language response through not only the speaker 160 but also the display 150.

In the above embodiments, it has been described that the natural language understanding module 420 changes the first text to the second text, but this is an example, and the first text may be changed to the second text through the dialogue manager module 430 or a module in which the natural language understanding module 420 and the dialogue manager module 430 are integrated.

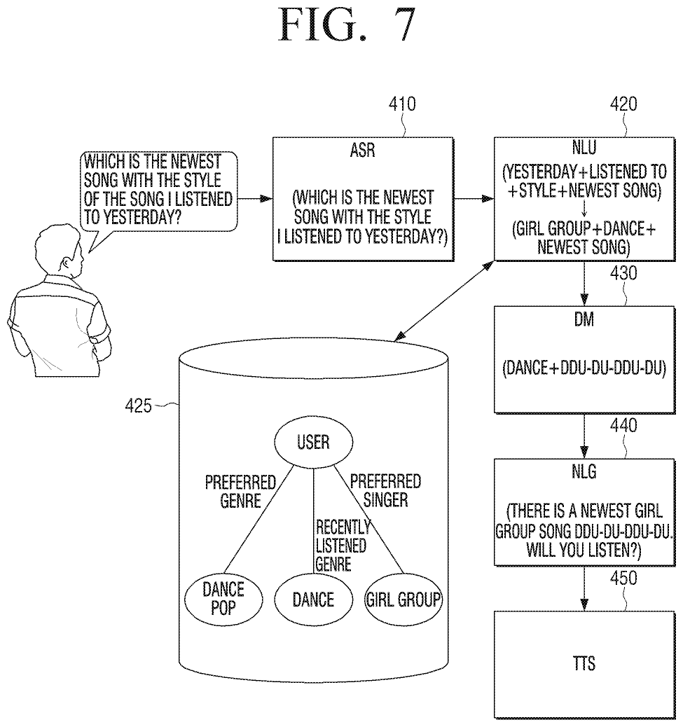

FIG. 7 is a view provided to describe a first example of changing a text based on user preference information according to embodiments.

The electronic device 100 may receive a user voice, “which is the newest song with the style of the song I listened to yesterday.” At this time, the electronic device 100 may receive a user voice including a predetermined trigger word (for example, Bixby), activate the AI agent, and then receive a user voice including the user inquiry.

The ASR module 410 may recognize the user voice in an audio format as a text format of “what is the newest song with the style of the song I listened to yesterday.”

The natural language understanding module 420 may acquire the intention of “search” and parameters (or slots) of “yesterday, listened, style, newest song” using “what is the newest song with the style of the song I listened to yesterday?” in a text format.

The dialogue manager module 430 may determine whether there is a response corresponding to the intention and the parameters acquired through the natural language understanding module 420 by using knowledge information stored in the personal knowledge base. At this time, if the response corresponding to the intention and the parameters acquired through the natural language understanding module 420 are present in the personal knowledge base (that is, knowledge information on a music similar to the newest song in a style of the song listened to yesterday is present in the personal knowledge base), the dialogue manager module 430 may provide the response to the user inquiry based on knowledge information stored in the personal knowledge base.

However, if the response corresponding to the intention and the parameters acquired through the natural language understanding module 420 is not present in the personal knowledge base, the dialogue manager module 430 may request the natural language understanding module 420 to change a part of the text included in the user inquiry.

The natural language understanding module 420 may determine a parameter related to either one or both of the user preference information and user history information, among the acquired parameters, as another parameter. For example, the natural language understanding module 420, based on the latest listening genres and preferences stored in a personal knowledge base such as a bar shown in FIG. 7, may change the “the newest song in a style of the song I listed to yesterday” to a “newest song of girl group dance” based on recently listened genre and a preferred singer stored in the personal knowledge base 425 as illustrated in FIG. 7.

The dialogue manager module 430 may generate a search keyword using a changed parameter and transmit the search keyword to an external response providing server 50. That is, the dialogue manager module 430 may transmit keywords “girl group, dance, newest song” to the external response providing server 50.

According to embodiments, to confirm the changed text, the dialogue manager module 430 may provide a confirmation message “Shall I search the newest song of the girl group dance.” In addition, if a positive feedback (for example, “Yes”) is received, the dialogue manager module 430 may transmit the search keyword including the changed parameters to the external response providing server 50.

The dialogue manager module 430 may receive the response of “dance, DDU-DU-DDU-DU” from the response providing server 50.

Then, the natural language generation module 440 may generate a natural language response based on the acquired response, “There is a newest song of girl group style DDU-DU-DDU-DU, will you listen” based on the acquired response.

The TTS module 450 may process the acquired natural language response as a voice and output the voice through the speaker 160. The electronic device 100 may provide the natural language response through not only the speaker 160 but also the display 150.

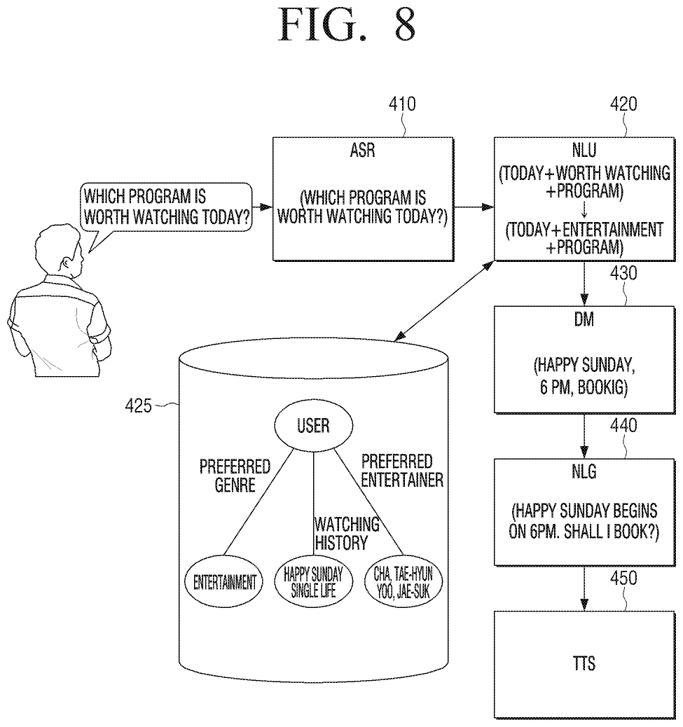

FIG. 8 is a view provided to describe a second example of changing a text based on user preference information according to embodiments.

The electronic device 100 may receive an input of a user voice “Which program is worth watching” through a microphone. At this time, after receiving the user voice including the predetermined trigger word (for example, the Bixby), the electronic device 100 may activate the AI agent and receive the user voice including the user inquiry.

The ASR module 410 may recognize the user voice in an audio format as a text format of “which program is worth watching.”

The natural language understanding module 420 may acquire the intention of “search” and parameters (or slots) of “today, worth watching, program” using “which program is worth watching today?” in a text format.

The dialogue manager module 430 may determine whether there is a response corresponding to the intention and the parameters acquired through the natural language understanding module 420 by using knowledge information stored in the personal knowledge base. At this time, if there is a response corresponding to the intention and the parameters acquired through the natural language understanding module 420 in the personal knowledge base (that is, if the knowledge information on the program worth watching today is present in the personal knowledge base), the dialogue manager module 430 may provide a response to the user inquiry based on knowledge information stored in the personal knowledge base.

However, when a response corresponding to the intention and parameters acquired through the natural language understanding module 420 is not present in the personal knowledge base, the dialogue manager module 430 may request the natural language understanding module 420 to change a part of the texts included in the user inquiry.

The natural language understanding module 420 may determine parameters related to either one or both of the user preference information and user history information, from among the acquired parameters, as another parameter. For example, the natural language understanding module 420 may change “worth watching” to “entertainment” based on the preferred genre stored in the personal knowledge base 425 as illustrated in FIG. 8.

The dialogue manager module 430 may generate a search keyword using the changed parameter and transmit the keyword to the external response providing server 50. That is, the dialogue manager module 430 may transmit the keywords “today, entertainment, program” to the external response providing server 50.

According to embodiments, to confirm the changed text, the dialogue manager module 430 may provide a confirmation message “shall I search an entertainment program worth watching today.” In addition, if a positive feedback (for example, “Yes”) is received through the confirmation message, the dialogue manager module 430 may transmit the search keyword including the changed parameters to the external response providing server 50.

The dialogue manager module 430 may receive a response “Happy Sunday, 6 pm, booking” from the response providing server 50.

The natural language generation module 440 may generate a natural language response “Happy Sunday begins on 6 pm. Shall I book?” based on the acquired response.

The TTS module 450 may process the acquired natural language response as a voice and output the voice through the speaker 160. The electronic device 100 may provide a natural language response through not only the speaker 160 but also the display 150.

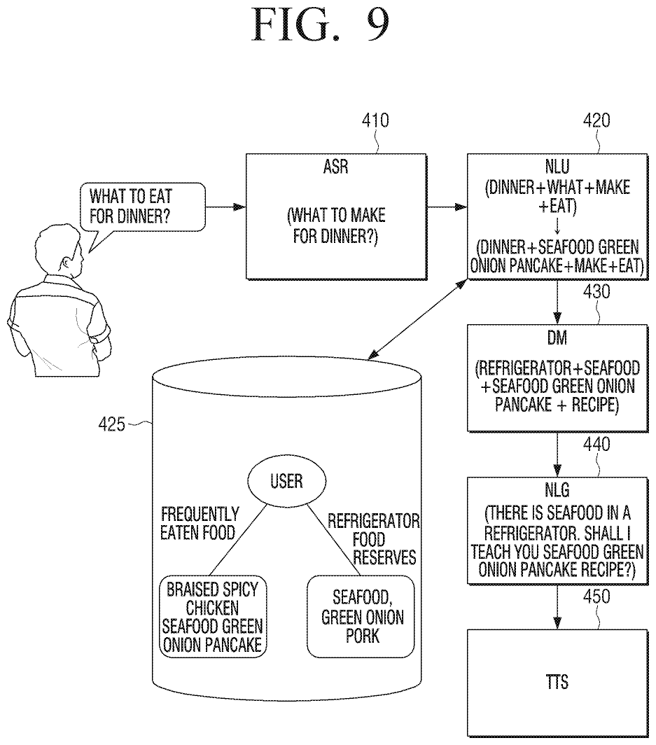

FIG. 9 is a view provided to describe a third example of changing a text based on user preference information, according to embodiments.

The electronic device 100 may receive a user voice “what to eat for dinner” through the microphone. At this time, after the electronic device 100 receives the user voice including the predetermined trigger word (for example, the Bixby), the electronic device 100 may activate the AI agent and receive the user voice including the user inquiry.

The ASR module 410 may recognize the user voice in an audio format as a text format of “what to make and eat for dinner.”

The natural language understanding module 420 may acquire the intention of “search” and parameters (or slots) of “dinner, make and eat.”

The dialogue manager module 430 may determine whether there is a response corresponding to the intention and parameters acquired through the natural language understanding module 420 by using knowledge information stored in the personal knowledge base. At this time, if there is a response corresponding to the intention and parameters acquired through the natural language understanding module 420 (that is, if the knowledge information on the food that the user will eat for dinner is in the personal knowledge base), the dialogue manager module 430 may provide a response to the user inquiry based on knowledge information stored in the personal knowledge base.

However, if there is no response corresponding to the intention and parameters acquired through the natural language understanding module 420, the dialogue manager module 430 may request the natural language understanding module 420 to change a part of the text included in the user inquiry.

The natural language understanding module 420 may determine a parameter that is related to either one or both of the user preference information and the user history information as another parameter. For example, the natural language understanding module 420 may change “what” to “seafood and green onion pancake” based on frequently-eaten food stored in the personal knowledge base 425 as illustrated in FIG. 9.

The dialogue manager module 430 may receive a response of “refrigerator, seafood, seafood and green onion pancake, recipe” using the changed parameter. At this time, the dialogue manager module 430 may use the external response providing server 50, but this is an example, and may acquire a response using the personal knowledge base 425 stored inside the electronic device 100.

The natural language generation module 440 may generate a natural language response of “there is a seafood in a refrigerator. Shall I teach you a recipe of seafood green onion pancake?”

The TTS module 450 may process the acquired natural language response as a voice and output the voice through the speaker 160. The electronic device 100 may provide a natural language response through not only the speaker 160 but also the display 150.

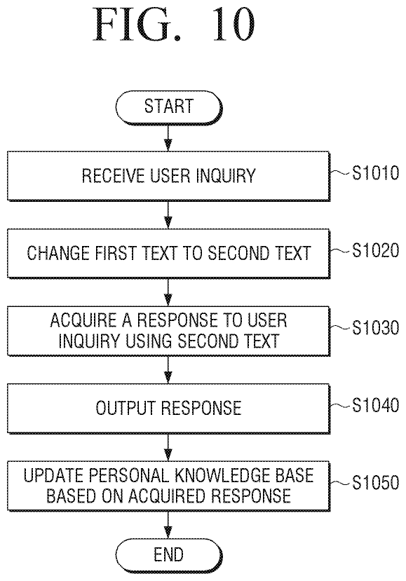

FIG. 10 is a flowchart to describe a controlling method for an electronic device to provide a response to a user inquiry, according to embodiments.

The electronic device 100 may receive a user inquiry in step S1010. The user inquiry may include a text that a user personally uses, and a text related to the user preference information, and the user history information.

The electronic device 100 may change a first text included in the user inquiry to a second text in step S1020. The electronic device 100 may change the first text to be included in the user inquiry to the second text using the personal knowledge base stored in the electronic device. The personal knowledge base may be learned based on any one or any combination of the user profile information, user interaction input to the electronic device 100, user search history, sensing information sensed by the electronic device 100, and user information received from the external device connected to the electronic device 100. The electronic device 100 may generate the personal knowledge base by acquiring a knowledge graph including relation information among knowledge information by inputting any one or any combination of user profile information, user interaction input to the electronic device 100, user search history, sensing information sensed by the electronic device 100, user information received from an external device.

The electronic device 100 may acquire a response to the user inquiry using the second text in step S1030. The electronic device 100 may generate a search keyword using the second text, provide the keyword to the external response providing server 50, and acquire a response to the search keyword from the external response providing server 50. That the electronic device 100 acquires the response using the external response providing server 50 is an example, and the electronic device 100 may acquire a response using the knowledge base inside the electronic device 100.

The electronic device 100 may output the acquired response in step S1040. At this time, the electronic device 100 may provide the acquired response through natural language processing.

The electronic device 100 may update the personal knowledge base based on the acquired response in step S1050. The electronic device 100 may add, delete, or modify the knowledge information stored in the personal knowledge base and a relation thereof, based on the user inquiry and acquired response. The electronic device 100 may update the user inquiry and the acquired response to the personal knowledge base based on the user feedback for the response to the user inquiry.

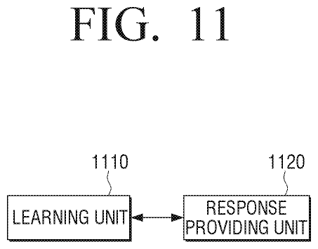

FIG. 11 is a view provided to describe an operation of an electronic device using an AI model, according to embodiments.

The memory 130 may include a learning unit 1110 and a response providing unit 1120. The processor 140 may execute the learning unit 1110 stored in the memory 130 so that the AI agent has a criterion for providing a response. The learning unit 1110 according to the disclosure may train a voice recognition model to have a purpose according to voice recognition. Alternatively, the learning unit 1110 according to the disclosure may train the natural language generation model to generate a natural language corresponding to the user's intention. The learning unit 1110 according to the disclosure may train a text change model for changing the text included in the user inquiry to another text. Alternatively, the learning unit 1110 may learn a response providing model for providing a response to the user inquiry based on the knowledge information stored in the knowledge base. The learning unit 1110 may also learn an AI model for generating a personal knowledge base model based on the acquired user information.

The processor 140 may execute the response providing unit 1120 stored in the memory 130, and the AI agent may determine a response to an inquiry based on input data. The response providing unit 1120 may acquire a response from predetermined input data using the learned response providing model. At this time, the response providing unit 1120 may provide a response in a natural language form using the natural language generation model. The response providing unit 1120 may change a text included in the user inquiry to another text using the text changing model to acquire a response.

The response providing unit 1120 may acquire predetermined input data according to a predetermined criteria and determine (or estimate) a predetermined response based on the predetermined input data, by applying the acquired input data to the response providing model as an input value. In addition, a result value that is output by applying the acquired input data to the response providing model as the input value may be used for updating the response providing model.

At least a portion of the learning unit 1110 and at least a portion of the response providing unit 1120 may be implemented as software modules or at least one hardware chip form and mounted in the electronic device 100. For example, either one or both of the learning unit 1110 and the response providing unit 1120 may be manufactured in the form of an exclusive-use hardware chip for artificial intelligence (AI), or a conventional general purpose processor (e.g., a CPU or an application processor) or a graphics-only processor (e.g., a GPU) and may be mounted on various electronic devices as described above. Herein, the exclusive-use hardware chip for artificial intelligence is a dedicated processor for probability calculation, and it has higher parallel processing performance than existing general purpose processor, so it can quickly process computation tasks in artificial intelligence such as machine learning. When the learning unit 1110 and the response providing unit 1120 are implemented as a software module (or a program module including an instruction), the software module may be stored in a computer-readable non-transitory computer readable media. In this case, the software module may be provided by an operating system (OS) or by a predetermined application. Alternatively, some of the software modules may be provided by an O/S, and some of the software modules may be provided by a predetermined application.

In this case, the learning unit 1110 and the response providing unit 1120 may be mounted on one server, or may be mounted on separate servers, respectively. For example, one of the learning unit 1110 and the response providing unit 1120 may be included in the first server, and the other one may be included in the second server. In addition, the learning unit 1110 and the response providing unit 1120 may provide the model information constructed by the learning unit 1110 to the response providing unit 1120 via wired or wireless communication, and provide data that is input to the response providing unit 1120 to the learning unit 1110 as additional data.

Also, the response providing model may be constructed considering the application field of the recognition model, the purpose of learning, or the computer performance of the device. The response providing model may be, for example, a model based on a neural network. The response providing model may be designed to simulate the human brain structure on a computer. The response providing model may include a plurality of weighted network nodes that simulate a neuron of a human neural network. The plurality of network nodes may each establish a connection relation so that the neurons simulate synaptic activity of transmitting and receiving signals through synapses. The response providing model may include, for example, a neural network model or a deep learning model developed from a neural network model. In the deep learning model, a plurality of network nodes is located at different depths (or layers) and may exchange data according to a convolution connection relation. For example, models such as deep neural network (DNN), recurrent neural network (RNN), and bidirectional recurrent deep neural network (BRDNN) may be used as response providing models, but are not limited thereto.

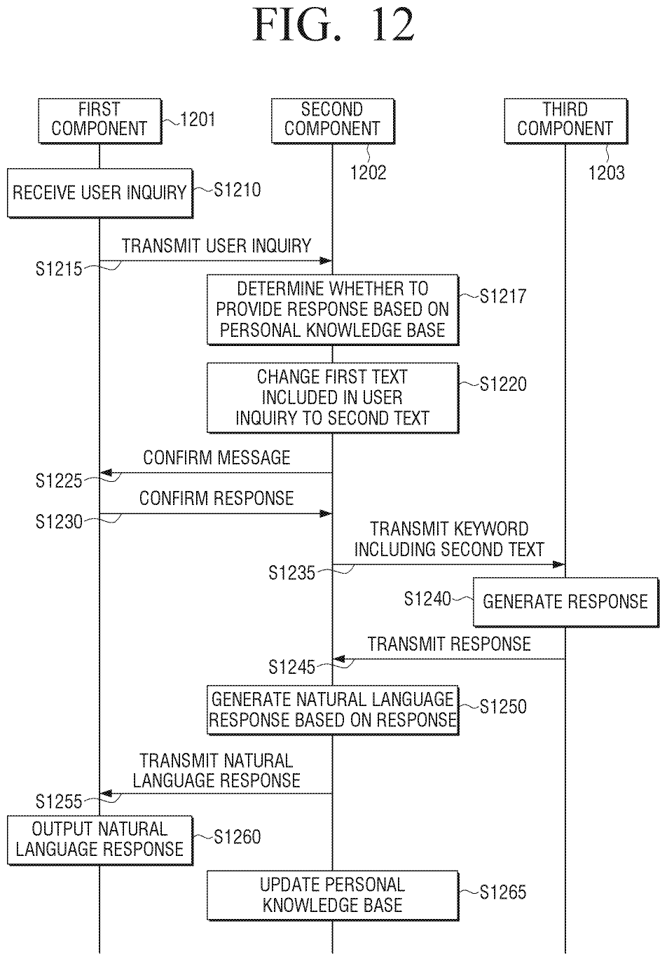

FIG. 12 is a flowchart of a network system using an AI agent model according to embodiments.

In FIG. 12, the network system using the AI agent may include a first component 1201, a second component 1202, and a third component 1203.

Here, the first component 1201 may be the electronic device 100 and the second component 1202 may be the server S storing the AI agent. Alternatively, the first component 1201 may be a general purpose processor and the second component 1202 may be an AI dedicated processor. Alternatively, the first component 1201 may be at least one application, and the second component 1202 may be an operating system (OS). That is, the second component 1202 may be more integrated than the first component 1201, may be dedicated, delay less, have an outstanding performance, or have many resources. The second component 1202 may be a component that can process many operations for operating the AI agent faster and more efficiently than the first component 1201.

In this case, an interface for transmitting/receiving data between the first component 1201 and the second component 1202 may be defined. For example, an application program interface (API) having an argument value (or an intermediate value or a transfer value) of learning data to be applied to the AI agent may be defined. The API may be defined as a group of subroutines or functions that may be called for any processing of any protocol (for example, a protocol defined in the electronic device A) to another protocol (e.g., a protocol defined in the server S). That is, an environment may be provided in which an operation of another protocol may be performed through any one protocol through the API.

The third component 1203 may provide a response to the user inquiry based on data received by either one or both of the first component 1201 and the second component 1202. The third component 1203 may correspond to, for example, the response providing server 50 of FIG. 1. According to still other embodiments, the third component 1203 may be implemented as a search engine server on the web or a server related to another AI assistant (voice assistant).

In FIG. 12, the first component 1201 may receive the user inquiry in step S1210.

The first component 1201 may transmit the user inquiry to the second component 1202 in step S1215.

The second component 1202 may determine whether to provide a response based on a personal knowledge base in step S1217. That is, if there is a response to the user query in the personal knowledge base, the second component 1202 may provide a response to the user query using the personal knowledge base. However, if there is no response to the user query in the personal knowledge base, the second component 1202 may determine whether there is a text to be converted, among the texts included in the user query, and receive a response to the user inquiry from the external response providing server 50.

The second component 1202 may convert a first text included in the user inquiry to a second text in step S1220. At this time, the second component 1202 may change the first text to the second text using the personal knowledge base stored in the electronic device 100 or the personal knowledge base that may be accessed only after a user logs into a user account in the server.

The second component 1202 may transmit a confirmation message confirming the changed second text to the first component 1201 in step S1225.

The first component 1201 may transmit a confirmation response for the confirmation message to the second component 1202 in step S1230.

The second component 1202 may transmit a keyword including the changed second text to the third component 1203 in step S1235.

The third component 1203 may generate a response based on the received keyword in step S1240, and transmit the generated response to the second component 1202 in step S1245.

The second component 1202 may generate a natural language response based on the response received from the third component 1203 in step S1250. That is, the second component 1202 may generate a natural language response using the natural language generation module.

The second component 1202 may transmit the natural language response to the first component 1201 in step S1255, and the first component 1201 may output the natural language response in step S1260.

The second component 1202 may update the personal knowledge base based on the user inquiry and the response received from the third component 1203 in step S1265. That is, the second component 1202 may add, delete, or modify the knowledge data stored in the personal knowledge base and a relation thereof, based on the user inquiry and response.

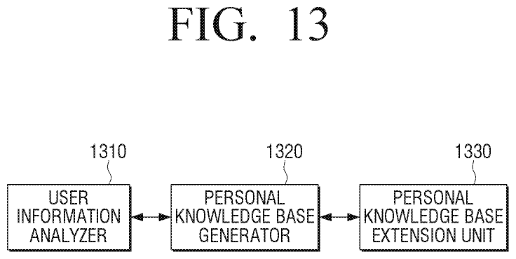

FIGS. 13, 14, 15A and 15B are views provided to describe a method for generating or expanding a personal knowledge base, according to embodiments.

FIG. 13 is a block diagram including a configuration to generate and expand the personal knowledge base, according to embodiments. The configuration of FIG. 13 may be implemented as a software format and stored in the memory 130, but this is an example, and the configuration may be implemented as a separate dedicated hardware chip.

A user information analyzer 1310 may analyze user information based on various information stored in the electronic device 100. The user information analyzer 1310 may analyze various information (for example, user preference information, user's body information, user's family information, or the like) related to the user based on the personal information, history of use of web or application, inquiry words, search words, web use screen capture, image-related information stored in the electronic device 100, contact information, location information, information related to social network service (SNS) uploaded by a user (image, text, and tag information), or the like. For example, when the user frequently searches an entertainer, watches a video of the entertainer a lot, and stores a lot of photos of the entertainer, the user information analyzer 1310 may acquire user information of “the user likes a specific entertainer.” As a still another example, when a user uploads a photo of a dog and a text “my dog, PuPu” on the SNS, the user information analyzer 1310 may acquire user information that “the user owns a dog named PuPu.”

The user information analyzer 1310 may analyze user information through various AI algorithms. For example, the user information analyzer 1310 may analyze an image using an AI model (for example, convolutional neural network (CNN) model) that is capable of acquiring information on an image object, and analyze a text using a text mining technology, or the like.

A personal knowledge base generator 1320 may generate knowledge information based on the user information acquired based on the user information analyzer 1310 and store the information in the personal knowledge base. For example, when use information “the user likes a specific entertainer” is acquired through the user information analyzer 1310, the personal knowledge base generator 1320 may store a relation between the user and the entertainer as a preferred entertainer. As a still another example, when user information “the user owns a dog named PuPu” is acquired through the user information analyzer 1310, the personal knowledge base generator 1320 may store a relation between the user and the dog as a pet, or store a relation between the dog and PuPu as a name.

The personal knowledge base generator 1320 may construct a relation among knowledge information or attribute of knowledge information acquired based on the user information through an external server. That is, when the relation between the user and the entertainer is stored as a preferred entertainer, the personal knowledge base generator 1320 may receive information on the diverse attributes of the preferred entertainer through an external server and construct the personal knowledge base.

A personal knowledge base extension unit 1330 may expand the personal knowledge base generated based on the user query and the response. For example, when a user queries a birthday for an entertainer and a response about the birthday date is acquired, the personal knowledge base extension unit 1330 may store the date included in the acquired response with the entertainer as a relation of a birthday date.

The personal knowledge base extension unit 1330 may expand (or update) the personal knowledge base by requesting, to the external server, knowledge related to whole or a part of the personal knowledge base through the communication interface 120, among the acquired knowledge information.

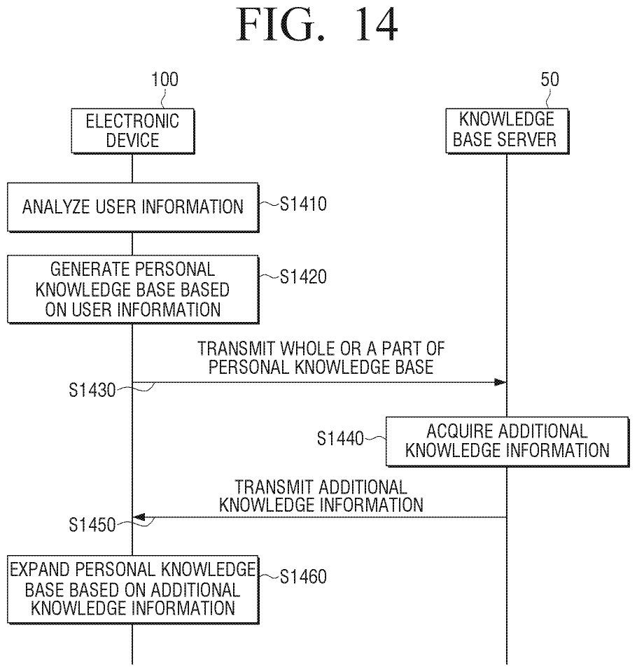

FIG. 14 is a sequence diagram provided to describe a method for generating and expanding the personal knowledge base according to embodiments.

The electronic device 100 may analyze user information in step S1410. The electronic device 100 may analyze user information collected in a diverse manner through the electronic device 100 and an external device connected to the electronic device 100. For example, the electronic device 100 may acquire user information that “the user owns Chihuahua of which name is PuPu.” Based on the photo of Chihuahua the user uploaded on SNS and a text “my dog PuPu.”

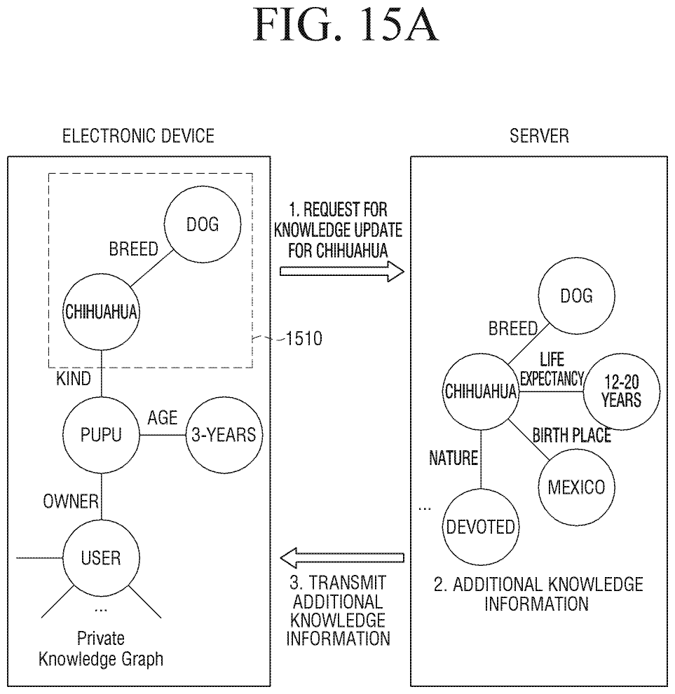

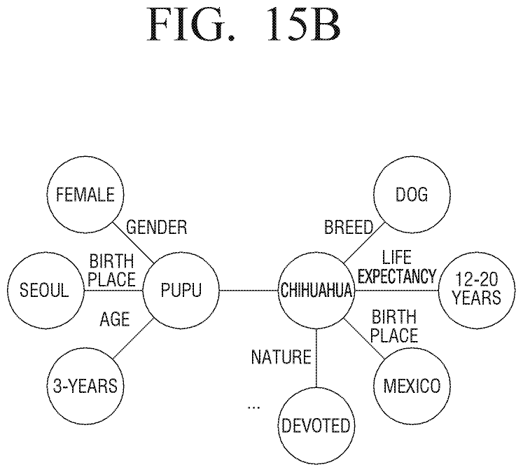

The electronic device 100 may generate a personal knowledge base based on the user information in step S1420. As an example, if the user information that “the user owns Chihuahua whose name is PuPuchi” is acquired, the electronic device 100 may acquire the relation information of ownership between the user and PuPu, as shown on the left side of FIG. 15A, acquire the relation information between PuPu and the Chihuahua, acquire the relation information of breed between the dog and the Chihuahua to generate a personal knowledge base. The electronic device 100 may transmit a part or whole of the personal knowledge base to the knowledge base server 1400 in step S1430. For example, the electronic device 100 may transmit knowledge information 1510, “a breed between a Chihuahua and a dog” shown on the left side of FIG. 15A, to the knowledge base server 1400, but this is an example, and transmit all the knowledge information 1510 shown on the left side of FIG. 15A to the knowledge base server 1400.

The knowledge base server 1400 may acquire additional knowledge information based on a part or whole of the received personal knowledge base in step S1440. For example, the knowledge base server 1400, as illustrated in the right side of FIG. 15A, may store various additional knowledge information such as life expectancy, place of birth, nature, or the like, based on the knowledge information 1510 of “breed between Chihuahua and dog.”

The knowledge base server 1400 may transmit the acquired additional knowledge information to the electronic device 100 in step S1450. The electronic device 100 may expand the personal knowledge base based on the additional knowledge information in step S1460. For example, the electronic device 100 may expand the personal knowledge base as illustrated in FIG. 15B, by combining the knowledge information stored in the personal knowledge base illustrated on the left side of FIG. 15A with the knowledge information received from the knowledge base server 1400 illustrated on the right side of FIG. 15A.

As described above, the electronic device 100 may expand the knowledge information stored in the personal knowledge base using the external knowledge base server 1400.

The term “unit” or “module” used in the disclosure includes units consisting of hardware, software, or firmware, and is used interchangeably with terms such as, for example, logic, logic blocks, parts, or circuits. A “unit” or “module” may be an integrally constructed component or a minimum unit or part thereof that performs one or more functions. For example, the module may be configured as an application-specific integrated circuit (ASIC).

The embodiments of the disclosure may be implemented as software that includes instructions stored in machine-readable storage media readable by a machine (e.g., a computer). A device may call instructions from a storage medium and that is operable in accordance with the called instructions, including an electronic apparatus (e.g., the electronic device 100). When the instruction is executed by a processor, the processor may perform the function corresponding to the instruction, either directly or under the control of the processor, using other components. The instructions may include a code generated or executed by the compiler or interpreter. The machine-readable storage medium may be provided in the form of a non-transitory storage medium. Here, “non-transitory” means that the storage medium does not include a signal and is tangible, but does not distinguish whether data is permanently or temporarily stored in a storage medium.

According to embodiments, a method disclosed herein may be provided in a computer program product. A computer program product may be traded between a seller and a purchaser as a commodity. A computer program product may be distributed in the form of a machine readable storage medium (e.g., CD-ROM) or distributed online through an application store (e.g., PlayStore™). In the case of on-line distribution, at least a portion of the computer program product may be stored temporarily or at least temporarily in a storage medium such as a manufacturer's server, a server in an application store, or a memory in a relay server.

Each of the components (for example, a module or a program) according to the embodiments may be composed of one or a plurality of objects, and some subcomponents of the subcomponents described above may be omitted, or other subcomponents may be further included in the embodiments. Alternatively or additionally, some components (e.g., modules or programs) may be integrated into one entity to perform the same or similar functions performed by each respective component prior to integration. Operations performed by a module, program, or other component, in accordance with the embodiments, may be performed sequentially, in a parallel, repetitive, or heuristic manner, or at least some operations may be performed in a different order, omitted, or other operations can be added.

What is claimed is:

1. An electronic device comprising:
a memory including at least one instruction; and
a processor configured to execute the at least one instruction to:
based on receiving a user inquiry, identify whether a response to the received user inquiry is present in a personal knowledge base that is included in the memory;
based on the response to the received user inquiry being identified to be present in the personal knowledge base, acquire the response to the received user inquiry, from the personal knowledge base; and
based on the response to the received user inquiry being identified to not be present in the personal knowledge base, change a first text included in the received user inquiry to a second text, and acquire, from an external server, the response to the received user inquiry, using the second text to which the first text is changed.

2. The electronic device of claim 1, wherein the personal knowledge base is learned based on any one or any combination of user profile information, a user interaction that is input to the electronic device, a user search history, sensing information that is sensed by the electronic device, and user information that is received from an external device.

3. The electronic device of claim 2, wherein the personal knowledge base stores one or more objects, a relation among the one or more objects, an attribute of the one or more objects in a format of a table or a graph, and includes data in which a relation or an attribute of the one or more objects is stored in a plurality of formats.

4. The electronic device of claim 2, wherein the processor is further configured to execute the at least one instruction to generate the personal knowledge base by inputting, to a learned artificial intelligence (AI) model, any one or any combination of the user profile information, the user interaction input to the electronic device, the user search history, the sensing information sensed by the electronic device, and the user information received from the external device, to acquire a knowledge graph including relation information among knowledge information, and
wherein the learned AI model is an AI algorithm that is learned using any one or any combination of machine learning, neural network, genetic, deep learning, and classification algorithms.

5. The electronic device of claim 2, wherein the processor is further configured to execute the at least one instruction to:
receive additional knowledge information from the external server, by requesting, from the external server, the additional knowledge information that is related to the personal knowledge base; and
expand the personal knowledge base, based on the received additional knowledge information.

6. The electronic device of claim 1, wherein the first text is not defined in a dictionary and is personally used by a user using the electronic device, and
wherein the second text corresponds to the first text, and is defined in the dictionary.

7. The electronic device of claim 1, wherein the second text is determined based on user history information and user preference information that are stored in the personal knowledge base, among a plurality of texts corresponding to the first text.

8. The electronic device of claim 1, wherein the processor is further configured to execute the at least one instruction to control to output a message for confirming the user inquiry in which the first text is changed to the second text.

9. The electronic device of claim 1, wherein the processor is further configured to execute the at least one instruction to:
generate a search keyword, using the second text to which the first text is changed;
control to transmit the generated search keyword to the external server; and
receive, from the external server, a response to the transmitted search keyword.

10. The electronic device of claim 9, wherein the processor is further configured to execute the at least one instruction to update the personal knowledge base, based on the received response to the transmitted search keyword.

11. A controlling method for an electronic device, the method comprising:
based on receiving a user inquiry, identifying whether a response to the received user inquiry is present in a personal knowledge base included in a memory of the electronic device;
based on the response to the received user inquiry being identified to be present in the personal knowledge base, acquiring the response to the received user inquiry, from the personal knowledge base; and
based on the response to the received user inquiry being identified to not be present in the personal knowledge base, changing a first text included in the received user inquiry to a second text, and acquiring, from an external server, the response to the received user inquiry, using the second text to which the first text is changed.

12. The controlling method of claim 11, wherein the personal knowledge base is learned based on any one or any combination of user profile information, a user interaction that is input to the electronic device, a user search history, sensing information that is sensed by the electronic device, and user information that is received from an external device.

13. The controlling method of claim 12, wherein the personal knowledge base stores one or more objects, a relation among the one or more objects, an attribute of the one or more objects in a format of a table or a graph, and includes data in which a relation or an attribute of the one or more objects is stored in a plurality of formats.

14. The controlling method of claim 12, further comprising generating the personal knowledge base by inputting, to a learned artificial intelligence (AI) model, any one or any combination of the user profile information, the user interaction input to the electronic device, the user search history, the sensing information sensed by the electronic device, and the user information received from the external device, to acquire a knowledge graph including relation information among knowledge information,
wherein the learned AI model is an AI algorithm that is learned using any one or any combination of machine learning, neural network, genetic, deep learning, and classification algorithms.

15. The controlling method of claim 12, further comprising:
receiving additional knowledge information from the external server, by requesting, from the external server, the additional knowledge information that is related to the personal knowledge base; and
expanding the personal knowledge base, based on the received additional knowledge information.

16. The controlling method of claim 11, wherein the first text is not defined in a dictionary and is personally used by a user using the electronic device, and
wherein the second text is a generalized text corresponding to the first text.

17. The controlling method of claim 11, wherein the second text is determined based on user history information and user preference information that are stored in the personal knowledge base, among a plurality of texts corresponding to the first text.

18. The controlling method of claim 11, further comprising outputting a message for confirming the user inquiry in which the first text is changed to the second text.

19. The controlling method of claim 11, further comprising:
generating a search keyword, using the second text to which the first text is changed;
transmitting the generated search keyword to the external server; and
receiving, from the external server, a response to the transmitted search keyword.

20. The controlling method of claim 19, further comprising updating the personal knowledge base, based on the received response to the transmitted search keyword.
